(19) United States
(12) Patent Application Publication
(10) Pub. No.: US 2005/0114893 A1
(43) Pub. Date: May 26, 2005

(54) Wi-Fi receiver system and method

(76) Inventor: Evans Wetmore, Manhattan Beach, CA (US)

Correspondence Address: SOFER & HAROUN, L.L.P.;Suite 910, 317 Madison Avenue, New York, NY, 10017, US

(21) Appl. No.: 10/723,177

(22) Filed: Nov. 26, 2003

(51) Int. Cl. H04N 7/18; H04N 7/20

(52) U.S. Cl. 725/71; 725/68; 725/70; 725/78

(57) ABSTRACT

A system for receiving computer communication network signals includes a first antenna configured to receive the communication network signals, and provide this signals to a coaxial cable. A satellite dish antenna is configured to receive satellite signals, and provide the satellite signals to a second coaxial cable. A combining network is configured to receive the communication network signals and the satellite signals, so as to combine the signals and provide the combined signal to a third coaxial cable. A splitting network is configured to receive the combined signal via the third coaxial cable. The splitting network is located within an enclosed building, and is configured to provide a first output signal corresponding to the computer communication network signals and a second output signal corresponding to the satellite signals. In accordance with another embodiment of the invention the computer communication network signal is a Wi-Fi signal and the first antenna is a Wi-Fi antenna connected to the satellite dish antenna.

### FIELD OF THE INVENTION

This invention relates to a wireless communication system and more specifically to a wireless fidelity (Wi-Fi) access arrangement.

### BACKGROUND OF THE INVENTION

Within the past few years the use of wireless networking to access Internet has experienced an exponential growth. Wireless local area networks, or WLANs, let anyone with a laptop and a modem get wireless Internet access from up to 300 feet away. One type of these networks is known as Wi-Fi, which is short for wireless fidelity. The operation of Wi-Fi, is governed by IEEE 802.11 standard for wireless networking.

Typically, a radio antenna is coupled via a receiver to the Internet via a cable or a DSL connection. The signals received by the receiver are in turn transmitted by the antenna. Any laptop computer or PDA equipped with a Wi-Fi antenna within the reception range of the transmitter is able to engage as a network node. As such a person using the laptop computer can communicate with other computers within the reception range or have a Web access.

Recently, many public institutions, such as restaurants, shopping centers, university campuses, airports, etc., have installed Wi-Fi antennas to provide public access to the Internet. Such public locations are known as “hot spots.” In addition, many municipalities are also installing Wi-Fi antennas around their cities allowing public to have wireless access anywhere within the city borders.

Although the number of such hot spots is rapidly increasing, users inside building structures have not been able to benefit from their presence. An occupant in a home or in an office is still not able to use a Wi-Fi antenna and receive signals from such hot spots reliably. In many instances the building construction and materials act as shields against receiving Wi-Fi signals.

Thus, in order to receive Wi-Fi signals indoors, a Wi-Fi antenna is coupled to an Internet cable or DSL and in turn transmits signals locally to all Wi-Fi receivers within its transmission range inside the building.

However, there is a need for a system that can reliably allow an indoor reception and use of Wi-Fi signals in a hot spot zone.

### SUMMARY OF THE INVENTION

In accordance with one embodiment of the invention, a Wi-Fi reception system includes a Wi-Fi antenna installed outside a building for receiving Wi-Fi signals. The antenna provides the received signal via a cable wire to a combining network. The combining network is configured to also receive via a second cable wire, a satellite signal received from a satellite dish antenna. The combining unit then provides the combined signal via a cable wire to a splitting network located inside the building. The splitting network provides a satellite signal and a Wi-Fi signal for use by the occupants inside the building.

In accordance with one embodiment of the invention, the splitting network is located within a set-top box. As such, the set-top box may provide the satellite signals to a TV receiver. The set-top box provides the Wi-Fi signals to a local transmitter for broadcasting the Wi-Fi signals to various Wi-Fi receivers in the building.

In accordance with another embodiment of the invention, the combining network further comprises a repeater module for amplifying the received Wi-Fi signal.

In yet another embodiment of the invention, the combining network further comprises a remodulator module, configured to demodulate the Wi-Fi signal, and then modulate it again in a different format than the original Wi-Fi modulation format.

The Wi-Fi antenna located outside the building in accordance with various embodiments of the invention is located at the low noise blocking unit of the satellite dish, or at the top edge of the dish. Furthermore, the combining network is also configured in accordance with another embodiment of the invention, to receive a signal from a TV aerial antenna.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a block diagram illustrating the location of a Wi-Fi antenna in accordance with various embodiments of the present invention.

FIG. 2 is a block diagram of a combining network receiving various signals in accordance with one embodiment of the present invention.

FIG. 3, is another block diagram of the combining network in accordance with one embodiment of the present invention.

FIG. 4 is a block diagram of a splitting network in accordance with one embodiment of the present invention.

### DETAILED DESCRIPTION OF THE DRAWINGS

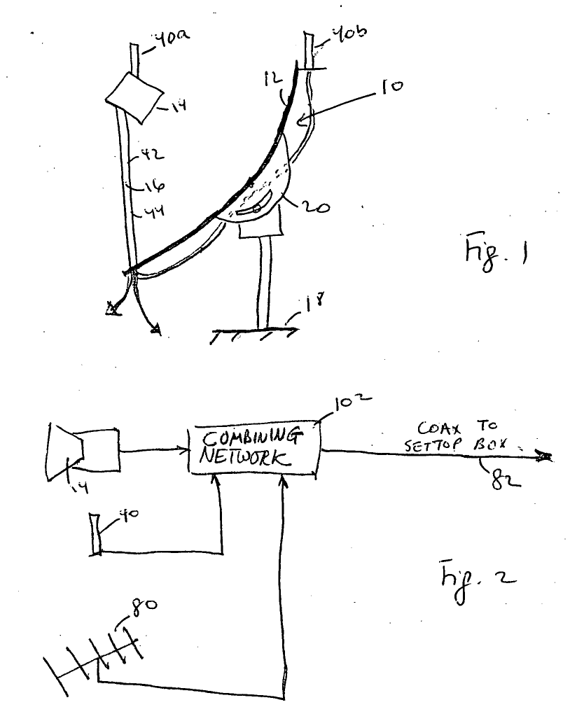

FIG. 1 illustrates a typical satellite dish 10 that is installed in a location outside a dwelling or an office for receiving satellite signals, such as satellite TV or radio signals. Dish 10 has a parabolic shaped reflector 12 for receiving communication signals and reflecting them to a low noise block 14. The low noise block in turns provides the collected communication signals to a coaxial cable 16 that runs through a low noise block mounting pole 42. Coaxial cable 16 is typically routed to a set-top box located inside the dwelling or the office. The set-top box, which is connected to a TV set, then provides satellite signals for viewing.

Satellite dish 10 is disposed on a mounting plate 18, via a tilt-height adjustment device 20. Typically, device 20 allows the user to adjust the position of reflector 12 for an optimum signal reception.

In accordance with one embodiment of the invention, Wi-Fi antenna 40a is located near the low noise block device 14. In accordance with one embodiment, antenna 40a is attached to low noise block device 14. A coaxial cable 44 is drawn from antenna 40a through mounting pole 16. It is noted that in accordance with other embodiments of the invention, Wi-Fi antenna 40a may be prefabricated along with satellite dish 10 as one unit.

It is appreciated by those skilled in the art that although the various embodiments of the present invention refer to Wi-Fi communication protocol, the invention is not limited in scope in that respect. For example any computer communication network protocol, including wired and wireless, is contemplated by the present invention, such as local area networks (LANs), metropolitan area networks (MANs) and wide area networks (WANs). All these communication protocols may be employed and corresponding antenna 40 is configured to receive signals that relate to these communication protocols. Therefore, once antenna 40 receives the corresponding signal, it can then provide it in accordance with the principles of the present invention, to inside a building for wireless or wired distribution of signals in accordance with a desired communication protocol.

Furthermore, in accordance with another embodiment of the invention, a Wi-Fi antenna 40b is coupled at or near the top edge of reflector 12 as illustrated in FIG. 1. A coaxial cable 44a is configured to carry the Wi-Fi signals received by antenna 40b. Again, it can be appreciated by those skilled in the art that Wi-Fi antenna 40b may be prefabricated along with satellite dish 10 as one unit.

It is also noted that although FIG. 1 illustrates Wi-Fi antennas 40 coupled to the satellite dish the invention is not limited in scope in that respect. For examples, Wi-Fi antenna 40 c, in accordance with one example of the invention, is disposed in a location near the satellite dish.

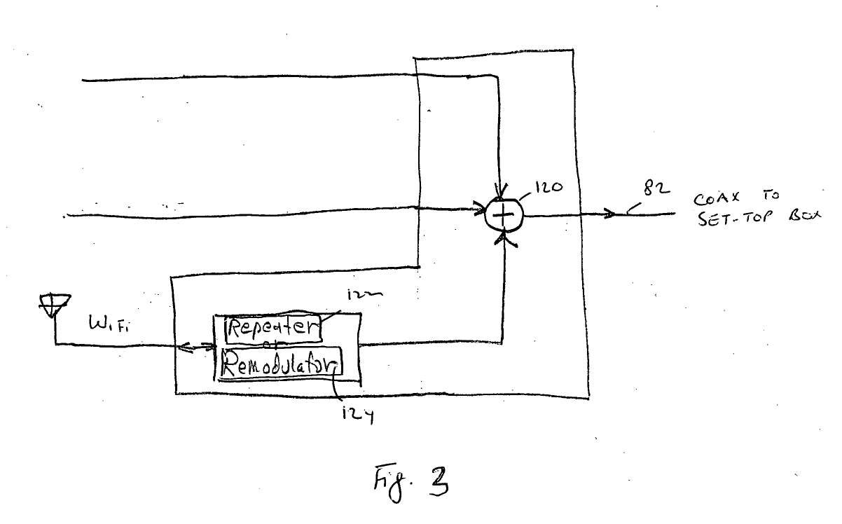

As illustrated in FIG. 2, the coaxial cables carrying satellite signals, Wi-Fi signals and VHF/UHF TV signals are all coupled to a combining network 102. Thus, an output port of low noise block 14 is coupled to an input port of combining network 102. Similarly, an output port of Wi-Fi antenna 40 is coupled to another input port of combining network 102. Similarly, an output port of TV antenna 80 is coupled to still another input port of combining network 102.

In accordance with one embodiment of the invention, combining network 102 is located somewhere on the satellite dish or its vicinity as illustrated in FIG. 1. Combining network 102 includes an output port that is configured to provide a combination signal to a coaxial cable 82, which in turn is configured to carry the combined signal to a set-top box located within the residence or the office building.

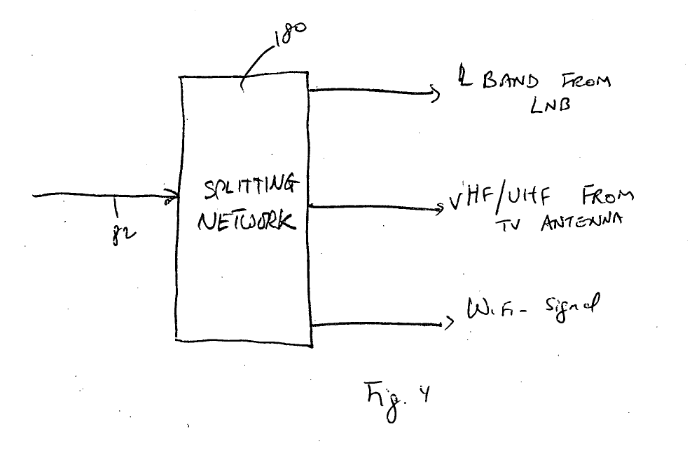

FIG. 3 illustrates a block diagram of a combiner network 102 in accordance with one embodiment of the present invention, although the invention is not limited in scope in that respect. For example, a multitude of combiner network designs can be implemented to combine the signals received via the satellite dish, the Wi-Fi antenna and the TV antenna.

In accordance with one embodiment of the invention, combiner network 102 includes a repeater 122 and a summing circuit 120. In accordance with another embodiment of the invention, combiner network 102 includes a remodulator 124 instead of repeater 122.

For the embodiment wherein the combiner network employs a repeater, the signal provided by the Wi-Fi antenna is coupled to an input port of repeater 122. In accordance with one embodiment of the invention, repeater 122 includes a bi-directional amplifier that is configured to amplify the Wi-Fi signals received by the antenna, before sending the signals to the set-top box.

Similarly, in the embodiment wherein the combiner network employs a remodulator, the signal provided by the Wi-Fi antenna is provided to an input port of remodulator 124. In accordance with one embodiment of the invention, remodulator 124 receives the Wi-Fi signal, and changes the signal to a different frequency and/or different form of modulation. For example, such a change may be accomplished by an heterodyning arrangement. In a more complex circuit, such a change may be accomplished with a Wi-Fi demodulator coupled to a modulator. Thus, the signal received from the Wi-Fi antenna is first demodulated and thereafter is fed to a modulator to be modulated in a scheme different from the Wi-Fi modulation scheme. It is appreciated by those skilled in the art that the remodulator allows the output frequency to be different from the input frequency leading to a better circuit stability.

Summing circuit 120 includes an input port for receiving the signals from the satellite dish. It also includes a second input port for receiving the signals from the TV antenna, and a third input port for receiving the signals from the Wi-Fi antenna via repeater 122 or remodulator 124. The output port of summing circuit 120 is coupled to coaxial cable 82 that carries the combined signal to the set-top box located inside the building.

FIG. 4 illustrates a splitting network 180 that is configured to receive the signals carried by coaxial cable 82 from outside the building. Splitting network 180 includes three output ports, each of which is configured to provide each of the signals that were combined by the combining network. Thus, the first output port of splitting network 180 provides the satellite signal received by the satellite dish. The second output port provides the TV signal received by the TV antenna. And the third output port provides the Wi-Fi signal received by the Wi-Fi antenna.

In accordance with one embodiment of the invention, splitting network 180 is configured as a separate box. As such the signal provided by the first output port can be coupled to a typical satellite dish receiver set-top box for processing the signals received from the satellite dish. Similarly, the signal provided by the second output port can be coupled to a TV input antenna port for processing the signals received from a TV antenna. Finally, the signal provided by the third output port can be coupled to a Wi-Fi broadcast antenna unit for processing the signals received from a Wi-Fi antenna.

It is noted that in accordance with one embodiment of the present invention, splitting network 180 is disposed inside a set-top box. The set-top box includes additional output ports for providing the signals received from the TV antenna and the Wi-Fi antenna. In accordance with another embodiment of the invention, the set-top box may also include a Wi-Fi broadcasting antenna for emitting Wi-Fi signals for use by Wi-Fi receivers located indoors.

Thus, during operation, Wi-Fi antenna 40 is configured to receive Wi-Fi signals that are emitted from Wi-Fi antennas located within the receiving vicinity of a building. As stated earlier, because of the construction constraints in a building, these signals may not be easily received inside a building. In order to be able to receive this signal internally, Wi-Fi antenna 40 is configured to receive this signal and route it to the inside of the building.

One advantage of combining the received Wi-Fi signal with a received satellite signal is that the same coaxial cable that is already installed to carry the satellite signal can be employed to carry the additional Wi-Fi signal. It is noted that although combining network 102 includes a repeater or a remodulator according to various embodiments of the invention, the invention is not limited in scope in that respect. For example, combiner network 102 in accordance with another embodiment of the invention, routes all the signals directly to a summing circuit 120.

The system described above in connection with FIGS. 1 through 4 may be marketed in accordance with various embodiments of the invention. For instance, for houses that already employ a satellite dish, a combiner box can be obtained along with the Wi-Fi antenna. The combiner box receives the signals from the Wi-Fi antenna and the satellite dish and sends the combined signal via the coaxial cable originally employed by the satellite dish receiver.

A separate splitter box is also obtained so as to receive the signals provided by the coaxial cable and separate them to their respective components of a Wi-Fi signal and a satellite signal.

The above system, in accordance with another embodiment of the invention can also be prefabricated. For example, a satellite dish receiver is configured to include a Wi-Fi antenna for receiving the outdoor Wi-Fi signals. The satellite dish may also include a combining network in accordance with the descriptions relating to FIGS. 1-4. Furthermore, the set-top box may include the splitting network for receiving and splitting the combined signals. Thus, the set-top box acts both as a satellite dish receiver and as an indoors Wi-Fi signal transmitter.

While only certain features of the invention have been illustrated and described herein, many modifications, substitutions, changes or equivalents will now occur to those skilled in the art. It is therefore, to be understood that the appended claims are intended to cover all such modifications and changes that fall within the true spirit of the invention.

1. A system for receiving computer communication network signals comprising:
a first antenna configured to receive said communication network signals, and provide this signals to a coaxial cable;
a satellite dish antenna configured to receive satellite signals, and provide this satellite signals to a second coaxial cable;
a combining network configured to receive said communication network signals and said satellite signals, said combining network configured to combine said signals and provide the combined signal to a third coaxial cable; and
a splitting network configured to receive said combined signal via said third coaxial cable, said splitting network located within an enclosed building, said splitting network further configured to provide a first output signal corresponding to said computer communication network signals and a second output signal corresponding to said satellite signals.

2. The system in accordance with claim 1, wherein said computer communication network signal is a Wi-Fi signal and said first antenna is a Wi-Fi antenna.

3. The system in accordance with claim 2, wherein said Wi-Fi antenna is connected to said satellite dish antenna.

4. The system in accordance with claim 3, wherein said Wi-Fi antenna is connected to LNB portion of said satellite dish antenna.

5. The system in accordance with claim 3, wherein said Wi-Fi antenna is connected to the upper portion of said satellite dish antenna.

6. The system in accordance with claim 2 further comprising a TV antenna configured to provide a TV signal to said combining network, so that the output port of said combining network includes a combined signal defined by said Wi-Fi signal, said satellite signal and said TV signal.

7. The system in accordance with claim 2 wherein said combining network further comprises an adder configured to receive said Wi-Fi signal and said satellite signal.

8. The system in accordance with claim 7, wherein said combining network further comprises a repeater configured to receive said Wi-Fi signal and generate an amplified version of said Wi-Fi signal to said adder.

9. The system in accordance with claim 7, wherein said combining network further comprises a remodulator configured to receive said Wi-Fi signal so as demodulate said Wi-Fi signal and then modulate said demodulated signal in accordance with a different modulation scheme than the scheme originally employed to modulate said Wi-Fi signal.

10. The system in accordance with claim 2 further comprising a set-top box, wherein said splitting network is contained within said set-top box, said set-top box further comprising a first output port for providing said Wi-Fi signal and a second output port for providing said satellite signal.

11. The system in accordance with claim 10 further comprising a Wi-Fi transmitter, configured to receive said Wi-Fi signal provided by said splitting network, so as to transmit said Wi-Fi signal via a Wi-Fi antenna within said enclosed building.

12. A method for receiving computer communication network signals comprising:
receiving said computer communication network signals, and providing said signals to a coaxial cable;
receiving satellite signals, and providing said satellite signals to a second coaxial cable;
combining said computer communication network signals and said satellite signals, so as to provide the combined signal to a third coaxial cable; and
splitting said combined signal within an enclosed building, so as to provide a first output signal corresponding to said computer communication network signals and a second output signal corresponding to said satellite signals.

13. The method in accordance with claim 12, wherein said computer communication network signal is a Wi-Fi signal.

14. The method in accordance with claim 13, further comprising the step of receiving said Wi-Fi signal via a Wi-Fi antenna, and receiving said satellite signal via a satellite antenna, and connecting said Wi-Fi antenna to said satellite dish antenna.

15. The method in accordance with claim 14, wherein said Wi-Fi antenna is connected to LNB portion of said satellite dish antenna.

16. The method in accordance with claim 14, wherein said Wi-Fi antenna is connected to the upper portion of said satellite dish antenna.

17. The method in accordance with claim 13 further comprising the step of combining a TV signal with said Wi-Fi and satellite signals, so as to generate a combined signal defined by said Wi-Fi signal, said satellite signal and said TV signal.

18. The method in accordance with claim 13 further comprising the step of adding said Wi-Fi signal to said satellite signal.

19. The method in accordance with claim 18, further comprising the step of providing a repeater configured to receive said Wi-Fi signal so as to generate an amplified version of said Wi-Fi signal to said adder.

20. The method in accordance with claim 18, further comprising the step of remodulating said Wi-Fi signal so as demodulate said Wi-Fi signal and then modulate said demodulated signal in accordance with a different modulation scheme than the scheme originally employed to modulate said Wi-Fi signal.

21. The method in accordance with claim 13 further comprising the step of splitting said signals inside a set-top box, said set-top box further comprising a first output port for providing said Wi-Fi signal and a second output port for providing said satellite signal.

22. The method in accordance with claim 21 further comprising the step of transmitting said Wi-Fi signal via a Wi-Fi antenna within said enclosed building.
